(19) United States
(12) Patent Application Publication
(10) Pub. No.: US 2009/0277654 A1
(43) Pub. Date: Nov. 12, 2009

(54) Confined Space Concentrated Fire Suppressor

(76) Inventor: Bradley W. Boesel, Phoenix, AZ (US)

Correspondence Address: JENNINGS, STROUSS & SALMON, P.L.C., 201 E. WASHINGTON ST., 11TH FLOOR, PHOENIX, AZ, 85004, US

(21) Appl. No.: 12/463,363

(22) Filed: May 8, 2009

Related U.S. Application Data
(60) Provisional application No. 61/051,665, filed on May 8, 2008.

(51) Int. Cl. A62C 35/58

(52) U.S. Cl. 169/37

(57) ABSTRACT

An apparatus for delivering fire suppressant to a confined space, such as a trash dumpster, is disclosed. The unit attaches to the wall of the confined space and allows the operator to use it to suppress the fire from a safe distance.

### CROSS REFERENCE TO RELATED APPLICATIONS

This application claims the benefit of priority of U.S. Provisional Application Ser. No. 61/051,665, filed May 8, 2008.

### FIELD OF THE INVENTION

The present invention relates to apparatus for fighting fires, particularly in confined spaces such as trash receptacles.

### BACKGROUND OF THE INVENTION

Fighting fires in contained spaces, such as trash receptacles commonly known as dumpsters and similar contained spaces can be a hazardous undertaking. Such fires are frequently extinguished by a person holding a hose over the side of the container and dispensing fire suppressant into the container. This exposes the person to risks from flame, multiple potentially explosive items, and toxic chemical fumes. The present invention allows an operator to attach a dispensing unit to a wall of the enclosed space and retreat a safe distance while the suppressant is dispensed to put out the fire.

### BRIEF DESCRIPTION OF THE DRAWINGS

FIG. 1 is a perspective view of an embodiment of the device from the operator's side

FIG. 2 is a perspective view of the embodiment of FIG. 1 from the delivery side.

FIG. 3 is a side view of an embodiment of the invention in place on a container and showing a section view of the main body.

FIG. 4 is a top view of the embodiment of FIG. 3.

FIG. 5 is a perspective view of an embodiment of the device in place on a container from the operator side.

FIG. 6 is a perspective view of the embodiment in FIG. 5 from the delivery side.

FIG. 7 is a sectional view of one embodiment of the invention.

FIG. 8 is a perspective view showing a lifting bracket on an embodiment of the invention.

FIG. 9 is a view of an embodiment of the invention showing a mounting bracket for securing the invention to a fire apparatus or storage compartment.

FIG. 10 is a perspective view of an embodiment of the invention configured for use on a building window sill.

### DETAILED DESCRIPTION

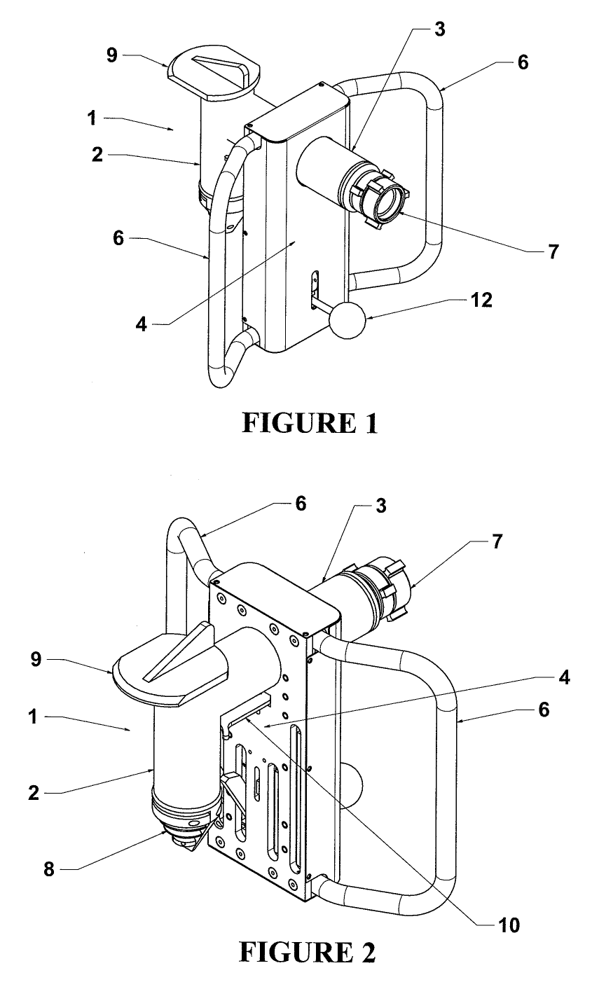

The instant invention is useful for delivering of a fire suppressant, such as water, into a confined space while the operator stands a distance away from the fire. Referring to FIGS. 1 and 2, one embodiment of the device comprises a tubular member (1) configured to form both a material delivery conduit and part of a clamping mechanism. The tubular member (1) may have an inside diameter sized to transmit the expected flow of fire suppressant, and it may have a cross section selected from a variety of shapes, with the preferred cross section being circular.

In one embodiment, tubular member (1) is in an approximately right-angle configuration, with a vertical leg (2) and a horizontal leg (3). The vertical leg (2) forms part of a clamping mechanism and has a delivery nozzle (8) at its extremity. The horizontal leg (3) of tubular member (1) is configured to connect at its extremity (7) to a source of fire suppressant, which may be, for example, a fire hose.

Tubular member (1) is connected to a main body (4), which in one embodiment is a rectangular box. Main body (4) has a handle or handles for setting the device in place for operation. In one embodiment, tubular side handle loops (6) are attached to either side of main body (4). For durability in an environment where the unit is attached to a fire hose and exposed to heat and fumes, the handle, body, tubular member, and any other component may be made of steel or any suitable material.

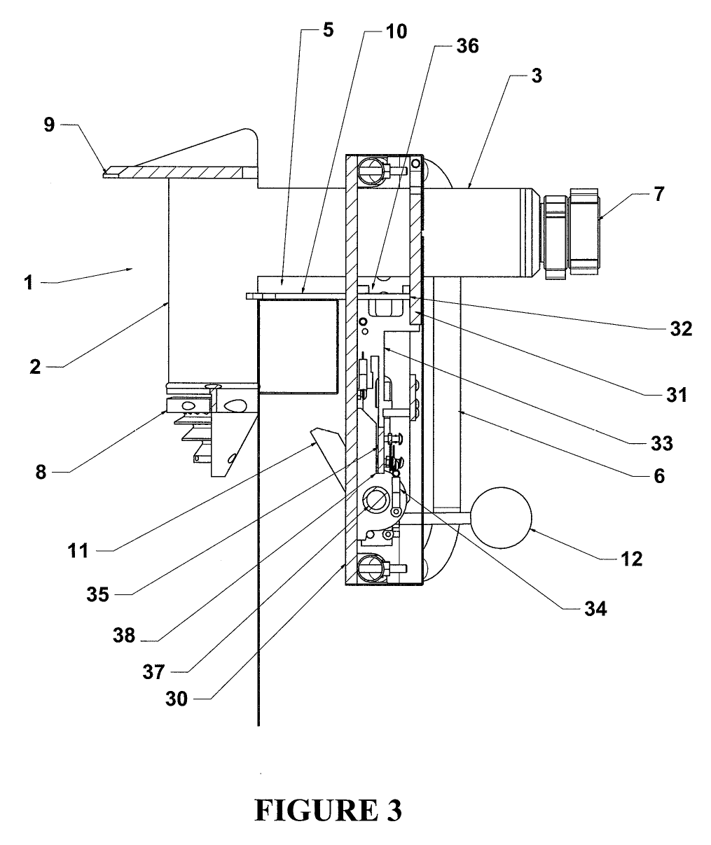

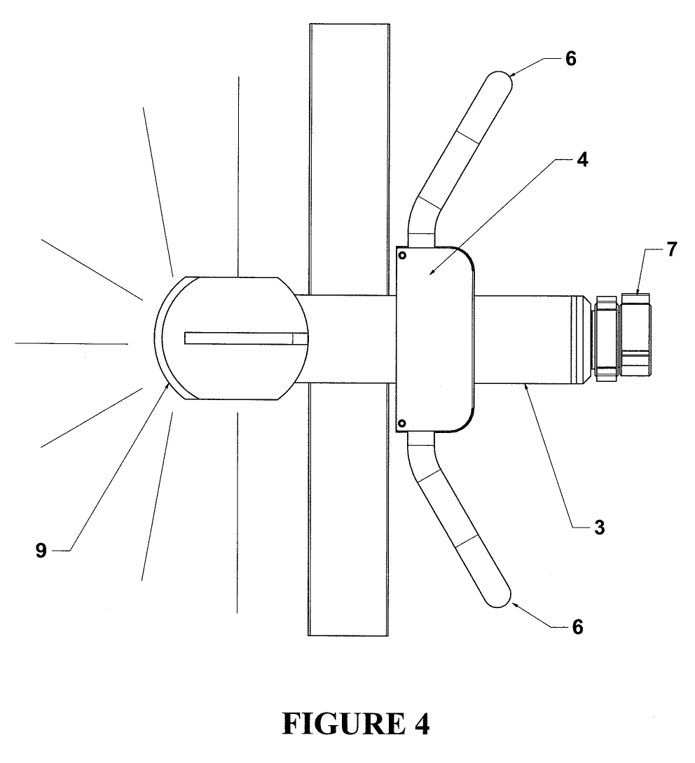

As seen in FIG. 3, the vertical leg (2) of tubular member (1) and main body (4) are roughly parallel, with a mounting space (5) between them for fitting over a wall portion of a confined space. The mounting space (5) should be wide enough to fit over the lip of a conventional trash dumpster and may advantageously be any practical size appropriate to the intended application.

One or more extendable members (11) are incorporated in main body (4), and may be deployed outwardly from the main body (4) toward the vertical leg (2) to tightly press against the wall of the enflamed container and hold the unit firmly in place and/or to secure the invention by engaging the under side of a lip or seam at the top of the wall and limiting vertical motion of the device. As seen in the embodiment illustrated in FIG. 3, extendable members (11) may be outwardly biased by an extended spring (34) and engaged with a series of elements connected to a trigger (10) which will automatically initiate deployment of the extendable members (11) as the device is placed and the free end of the trigger (10) is forced toward the horizontal leg (3). In this embodiment the trigger (10) extends through the base plate (30) of the main body (4) and intersects with the rigid upper body plate (31) to form a pivot (32). The trigger also engages a link plate (33) at a point (36) such that when the free end of the trigger (10) moves toward the horizontal leg (3) it pulls the link plate (33) towards the horizontal leg (3). The link plate (33) is in turn attached to a release plate (35) which engages a notch (38) in the extendable members (11) preventing them from rotating about a shaft (37). When the release plate (35) moves sufficiently far toward the horizontal leg (3) the release plate (35) disengages from the notch (36) in the extendable members (11) allowing the extendable members (11) to deploy by rotating about the shaft (37) powered by the contracting spring (34). The extendable members (11) may be configured so they operate in unison or operate separately. Optionally, the extendable members may be configured to deploy and/or retract manually, using a handle (12) on the rear portion of main body (4).

The extremity of the vertical leg (2) of the tubular member (1) is configured to accept attachment to one of a variety of dispersing nozzles (8) capable of various dispersion patterns. For example, a nozzle with a quarter spherical pattern may be used to deliver a deluge of water to the fire. The extremity (7) of the horizontal leg (3) of the tubular member (1) is configured to accept attachment to a flexible hose or hose-like conduit through which fire suppressant is delivered to the device. Part of the tubular member is configured to form a blade or lip (9) which may be inserted into a narrow space such as between the top of the dumpster wall and the lid of the dumpster and used to widen the narrow space so as to facilitate entrance of the tubular member into the space.

In one mode of operation of an embodiment of the device, a firefighter approaches a burning dumpster holding the unit in front of him by the side handles (6), with a fire hose attached at the input end (7) of tubular member (1) and draped over the firefighter's shoulder. If the dumpster cover is closed, the firefighter inserts the blade or lip (9) between the top of the container wall and the free edge of the lid and turns the device 90 degrees about the horizontal tubular member thus widening the opening just enough to insert the vertical leg (2) into the interior. After turning the vertical leg downward, the firefighter rests the unit on top of the wall and releases the extendable member or members (11), or manually extends these members, to secure the unit to the wall. The firefighter then withdraws a safe distance and turns on the hose, unleashing a deluge of water into the enclosure. When the fire is out, the unit may be retrieved.

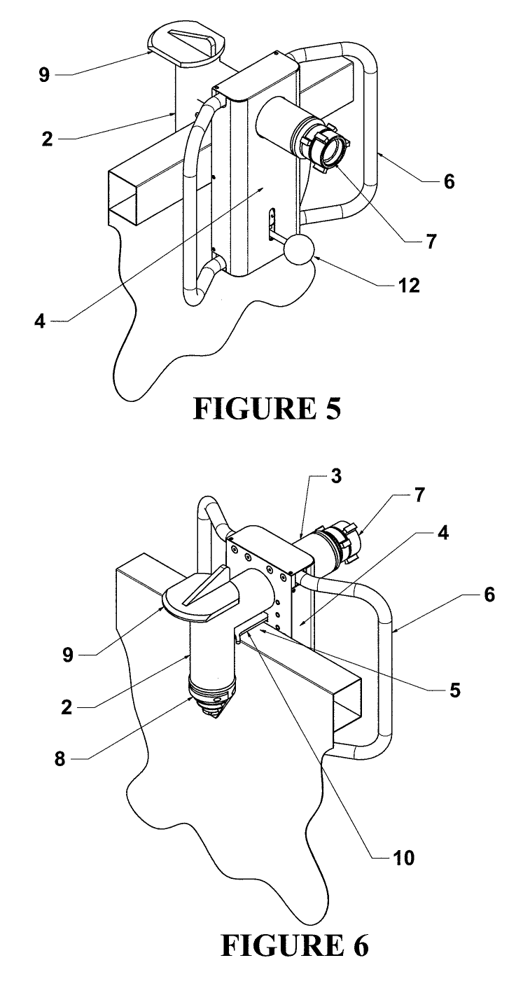

Referring to FIG. 5 a sleeve or other suitable containment device (20) may be placed within the horizontal leg (3) of the tubular member (1) for the purpose of holding and/or dispensing a fire suppressant modifying agent such as a solid chemical which converts water into foam. Said sleeve or holding device is firmly attached to the tubular member and may contain an auxiliary holder (21) with retaining device (22) specifically configured for a particular brand or form of suppressant modifier. Said sleeve or holding device is configured with appropriately sized and located openings (23) so as to direct the suppressant flow optimally around or through the modifying agent. Alternately said sleeve or containment device may be located within the vertical leg (2) of the tubular member (1). A further variant of said sleeve is a port or opening in the tubular member at some point arranged to introduce a suppressant modifier into the flow of suppressant.

Referring to FIG. 6 a suitably designed bracket (14) may be used with a pole or rod (15) of sufficient length to lift the device high enough to be placed on the free edge of a wall or partition when that free edge is too high for direct placement of the device using the handles (6). Alternatively a feature (16) to accept a lifting pole or rod may be incorporated directly into the structure for the purpose of lifting the device instead of having that capability in a separate bracket.

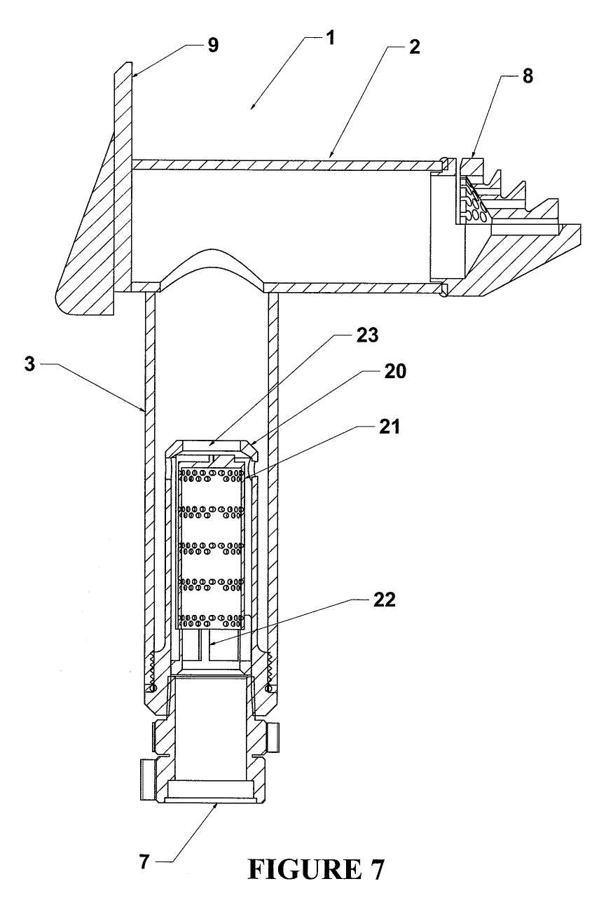

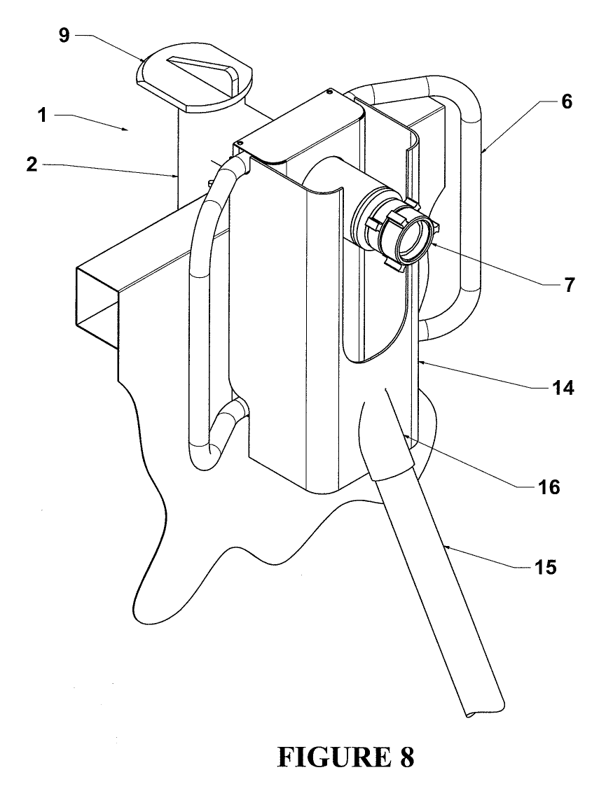

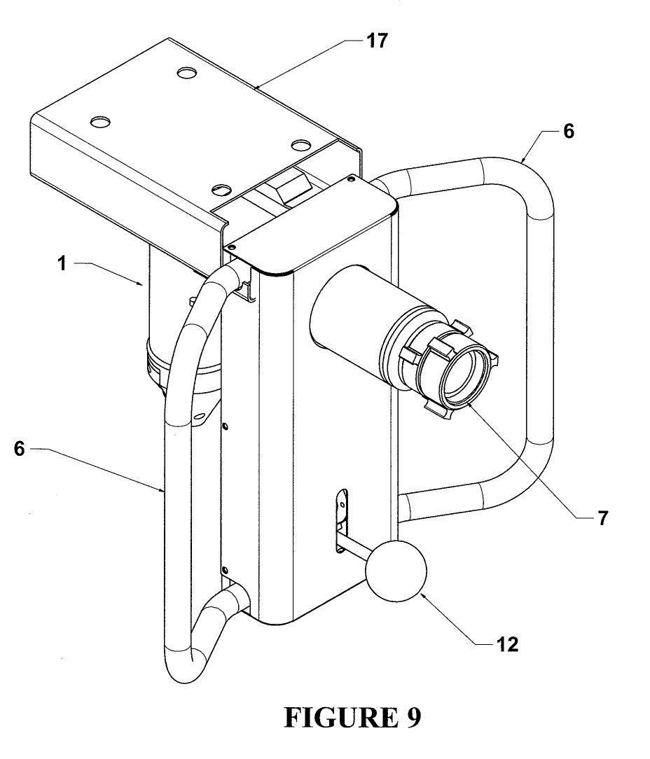

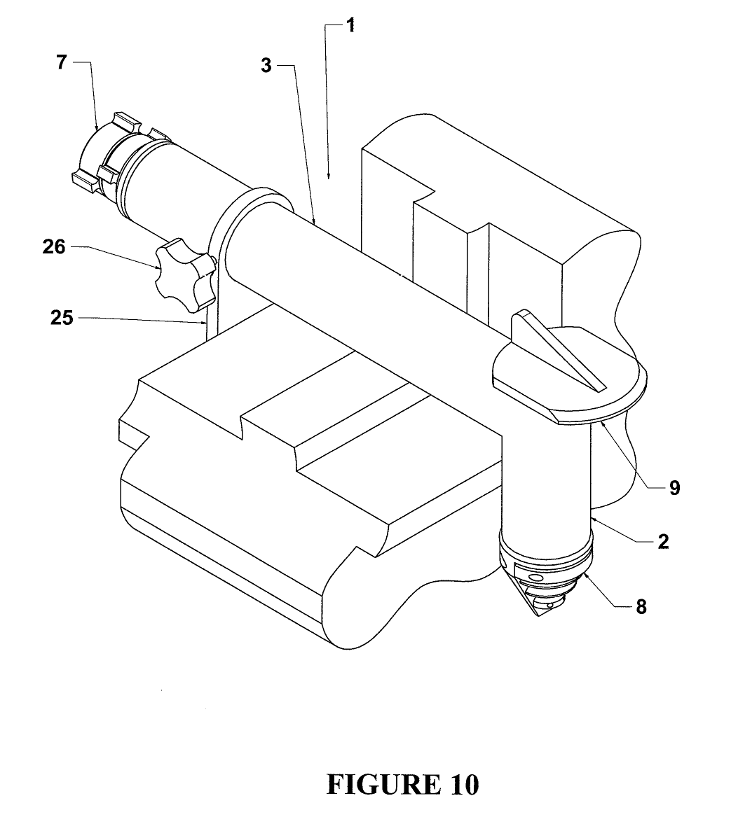

FIG. 7 shows an embodiment of the device that includes a mounting bracket (17) into which the device may be placed. Mounting bracket (17) is configured to support and restrain the device and may be attached to the top of a cabinet or compartment of a fire truck. Such a bracket will allow the device to be transported within a firefighting apparatus without taking up room on the floor of the apparatus compartment.

An alternate configuration of the device is designed to deliver non-liquid fire suppressant in a similar method to the device described above. The non-liquid fire suppressant may be delivered to the device through a flexible hose or a rigid connection attached at input end (7) of tubular member (1).

Additionally there may be other embodiments of the device appropriately sized and configured so as to be placed on window sills or other such existing portals in buildings or similar structures with the intent that the device will maintain its position and ability to deliver suppressant without human attention. FIG. 10 shows a portion of a typical building window with an embodiment of the device placed approximately in the corner of the window opening. As above the tubular member (1) is in an approximately right-angle configuration, with a vertical leg (2) and a horizontal leg (3). The vertical leg (2) forms part of a clamping mechanism and has a delivery nozzle (8) at its extremity. The horizontal leg (3) of tubular member (1) is configured to connect at its extremity (7) to a source of fire suppressant, which may be, for example, a fire hose. This embodiment employs a positionable member (25) which may be moved along the horizontal leg (3) so as to grip opposite sides of the window sill between the positionable member (25) and the vertical leg (2) to secure the device in position. The positionable member may be shaped in any suitable fashion to facilitate movement and clamping efficacy. The positionable member (25) is held in place along the horizontal leg (3) by a suitable clamp or latch shown here as a typical hand knob (26) threaded into the positionable member (25). The blade or lip (9) may be used to break the window glass to facilitate placement of the device on the window sill. Also as above the extremity of the vertical leg (2) of the tubular member (1) is configured to accept attachment to one of a variety of dispersing nozzles (8) capable of various dispersion patterns.

The foregoing description has been presented and is intended for the purposes of illustration and description. It is not intended to be exhaustive nor limit the invention to the precise form disclosed and many modifications and variations are possible in the light of the above teachings. The embodiments were chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention

What is claimed is:

1. A fire suppressor delivery device comprising
a tubular delivery member having a vertical leg and a horizontal leg, with a vertical extremity and a horizontal extremity;
a main body attached to the horizontal leg and parallel to the vertical leg;
a delivery nozzle attached to the vertical extremity;
an input connector attached to the horizontal extremity; and
a clamping mechanism for securely clamping a wall of an enclosure between the vertical leg and the main body so that the delivery nozzle is inside the enclosure and the input connector is accessible outside the enclosure.

2. The device of claim 1 further including a lifting blade capable of raising the lid of a container, attached on top of the horizontal leg.

3. The device of claim 1 further including a pair of loop handles attached to the main body.

4. The device of claim 1 wherein the clamping mechanism comprises at least one extendable member in the main body outwardly biased by an extended spring and connected to a trigger such that when the device is placed on a wall and the trigger is moved toward the horizontal leg the extendable member deploys toward the wall.

5. The device of claim 1 wherein the clamping mechanism is operated by an external handle connected to the extendable member and the main body.

6. The device of claim 1 further including a connection for a lifting pole to place the device on an elevated surface.

7. The device of claim 1 further including a bracket for mounting the device to a carrying compartment.

8. The device of claim 1 wherein the tubular member includes a sleeve for holding and disbursing a fire suppressant modifying agent as the suppressant flows through the tubular member.

9. A fire suppressor delivery device comprising
a tubular delivery member having a vertical leg and a horizontal leg, with a vertical extremity and a horizontal extremity;
a delivery nozzle attached to the vertical extremity;
an input connector attached to the horizontal extremity; and
a means for securely clamping the device to a wall of an enclosure so that the delivery nozzle is inside the enclosure and the input connector is accessible outside the enclosure.

10. The device of claim 9 wherein the clamping means comprises a positionable vertical member movable along the horizontal leg and capable of being secured in position firmly against the wall on the outside of the enclosure.

11. The device of claim 9 further including a lifting blade capable of raising the lid of a container, attached on top of the horizontal leg.

12. The device of claim 9 further including a pair of loop handles attached to the main body.

13. The device of claim 9 further including a connection for a lifting pole to place the device on a n elevated surface.

14. The device of claim 9 further including a bracket for mounting the device to a carrying compartment.

15. The device of claim wherein the tubular member includes a sleeve for holding and disbursing a fire suppressant modifying agent as the suppressant flows through the tubular member.

16. A fire suppressor delivery device comprising
a tubular delivery member having a vertical leg and a horizontal leg, with a vertical extremity and a horizontal extremity;
a main body attached to the horizontal leg and parallel to the vertical leg;
a delivery nozzle attached to the vertical extremity;
an input connector attached to the horizontal extremity; and
a clamping mechanism for securely clamping a wall of an enclosure between the vertical leg and the main body so that the delivery nozzle is inside the enclosure and the input connector is accessible outside the enclosure;
a lifting blade capable of raising the lid of a container, attached on top of the horizontal leg;
a pair of loop handles attached to the main body; and
a bracket for mounting the device to a carrying compartment.
